(19) United States
(12) Patent Application Publication
(10) Pub. No.: US 2025/0226002 A1
(43) Pub. Date: Jul. 10, 2025

(54) MAGNETIC HEAD AND MAGNETIC RECORDING DEVICE

(71) Applicants: KABUSHIKI KAISHA TOSHIBA, Tokyo (JP); TOSHIBA ELECTRONIC DEVICES & STORAGE CORPORATION, Tokyo (JP)

(72) Inventors: Tazumi NAGASAWA, Yokohama Kanagawa (JP); Yuji NAKAGAWA, Kawasaki Kanagawa (JP); Masayuki TAKAGISHI, Kunitachi Tokyo (JP); Naoyuki NARITA, Funabashi Chiba (JP); Tomoyuki MAEDA, Kawasaki Kanagawa (JP); Ryo OSAMURA, Kawasaki Kanagawa (JP); Junki NUMATA, Yokohama Kanagawa (JP)

(21) Appl. No.: 18/977,746

(22) Filed: Dec. 11, 2024

(30) Foreign Application Priority Data
Jan. 4, 2024 (JP) 2024-000345

(51) Int. Cl. G11B 5/39; G11B 5/012

(52) U.S. Cl. CPC G11B 5/3929; G11B 5/012

(57) ABSTRACT

According to one embodiment, a magnetic head includes a reproducing section including a medium facing face. The reproducing section includes a first magnetic element including a first magnetic layer, a second magnetic layer, and a third magnetic layer. The first magnetic layer is provided between the third magnetic layer and the second magnetic layer in a first direction along the medium facing face. A first magnetic layer magnetization of the first magnetic layer includes a first component along a second direction crossing the medium facing face. A second magnetic layer magnetization of the second magnetic layer includes a second component along the second direction. A direction of the second component is opposite to a direction of the first component. A third magnetic layer magnetization of the third magnetic layer includes a third component along a third direction crossing a plane including the first direction and the second direction.

### CROSS-REFERENCE TO RELATED APPLICATIONS

This application is based upon and claims the benefit of priority from Japanese Patent Application No. 2024-000345, filed on Jan. 4, 2024; the entire contents of which are incorporated herein by reference.

### FIELD

Embodiments described herein relate generally to a magnetic head and a magnetic recording device.

### BACKGROUND

Information recorded on a magnetic recording medium such as an HDD (Hard Disk Drive) is reproduced using a magnetic head that includes a magnetic sensor using a magnetic layer. It is desired to improve the characteristics of magnetic heads.

### BRIEF DESCRIPTION OF THE DRAWINGS

FIG. 1 is a schematic cross-sectional view illustrating a magnetic head according to a first embodiment;

FIG. 2 is a schematic cross-sectional view illustrating the magnetic head according to the first embodiment;

FIG. 3 is a schematic cross-sectional view illustrating the magnetic head according to the first embodiment;

FIG. 4 is a schematic cross-sectional view illustrating the magnetic head according to the first embodiment;

FIG. 5 is a schematic diagram illustrating the magnetic head according to the first embodiment;

FIGS. 6A to 6D are schematic diagrams illustrating the magnetic head according to the first embodiment;

FIG. 7 is a schematic cross-sectional view illustrating a magnetic head according to the first embodiment;

FIG. 8 is a schematic cross-sectional view illustrating a magnetic head according to the first embodiment;

FIG. 9 is a schematic cross-sectional view illustrating a magnetic head according to the first embodiment;

FIG. 10 is a schematic cross-sectional view illustrating a magnetic head according to the first embodiment;

FIG. 11 is a schematic cross-sectional view illustrating a magnetic head according to the first embodiment;

FIG. 12 is a schematic perspective view illustrating the magnetic head and a magnetic recording device according to a second embodiment;

FIG. 13 is a schematic perspective view illustrating a part of the magnetic recording device according to the embodiment;

FIG. 14 is a schematic perspective view illustrating the magnetic recording device according to the embodiment; and

FIGS. 15A and 15B are schematic perspective views illustrating a part of the magnetic recording device according to the embodiment.

### DETAILED DESCRIPTION

According to one embodiment, a magnetic head includes a reproducing section including a medium facing face. The reproducing section includes a first magnetic element. The first magnetic element includes a first magnetic layer, a second magnetic layer, and a third magnetic layer. The first magnetic layer is provided between the third magnetic layer and the second magnetic layer in a first direction along the medium facing face. A first magnetic layer magnetization of the first magnetic layer includes a first component along a second direction crossing the medium facing face. A second magnetic layer magnetization of the second magnetic layer includes a second component along the second direction. A direction of the second component is opposite to a direction of the first component. A third magnetic layer magnetization of the third magnetic layer includes a third component along a third direction crossing a plane including the first direction and the second direction.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

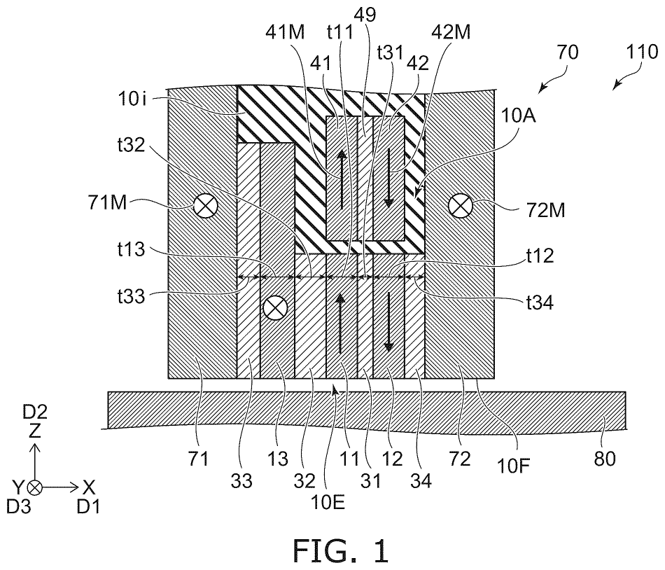

FIGS. 1 to 4 are schematic cross-sectional views illustrating a magnetic head according to the first embodiment.

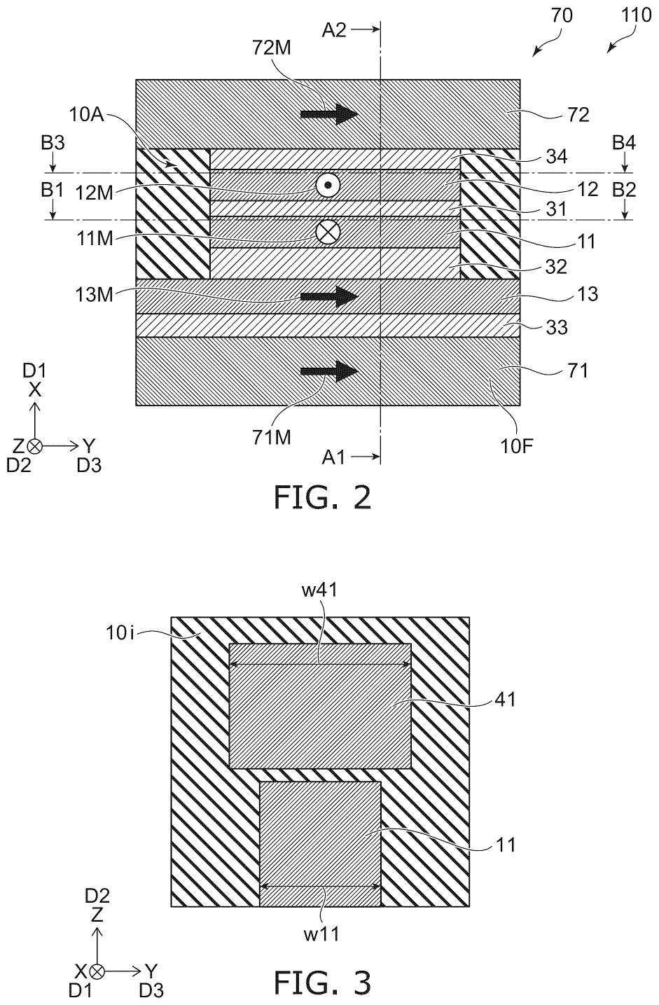

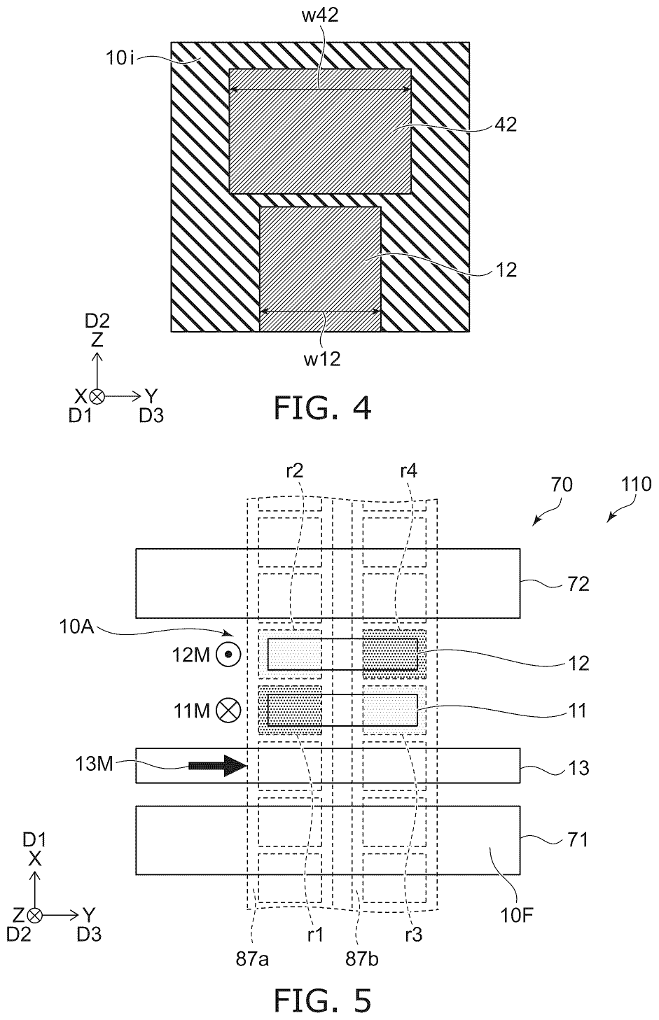

FIG. 1 is a sectional view taken along the line A1-A2 in FIG. 2. FIG. 3 is a sectional view taken along the line B1-B2 in FIG. 2. FIG. 4 is a sectional view taken along the line B3-B4 in FIG. 2.

As shown in FIG. 1, a magnetic head 110 according to the embodiment includes a reproducing section 70. The reproducing section 70 includes a medium facing face 10F. The medium facing face 10F faces a magnetic recording medium 80. The reproducing section 70 is configured to reproduce information recorded on the magnetic recording medium 80. The magnetic recording medium 80 is, for example, a perpendicular recording medium.

The reproducing section 70 includes a first magnetic element 10A. The first magnetic element 10A includes a first magnetic layer 11, a second magnetic layer 12, and a third magnetic layer 13. In a first direction D1 along the medium facing face 10F, the first magnetic layer 11 is provided between the third magnetic layer 13 and the second magnetic layer 12. The first magnetic layer 11, the second magnetic layer 12, and the third magnetic layer 13 are included in the reproducing element 10E, for example.

A direction perpendicular to the medium facing face 10F is defined as a Z-axis direction. One direction perpendicular to the Z-axis direction is defined as a X-axis direction. A direction perpendicular to the Z-axis direction and the X-axis direction is defined as a Y-axis direction. The Z-axis direction corresponds to, for example, the height direction. The X-axis direction corresponds to, for example, the down-track direction. The Y-axis direction corresponds to, for example, the cross-track direction. The first direction D1 may be, for example, the X-axis direction.

A first magnetic layer magnetization 11M of the first magnetic layer 11 includes a component (first component) along the second direction D2. The second direction D2 crosses the medium facing face 10F. The second direction D2 may be, for example, the Z-axis direction. The second direction D2 may be perpendicular to the medium facing face 10F.

A second magnetic layer magnetization 12M of the second magnetic layer 12 includes a component (second component) along the second direction D2. A direction of the second component is opposite to the direction of the first component.

For example, the second magnetic layer 12 is antiferromagnetically coupled with the first magnetic layer 11. A third magnetic layer magnetization 13M of the third magnetic layer 13 includes a component (third component) along the third direction D3. The third direction D3 crosses a plane including the first direction D1 and the second direction D2. The third direction D3 is, for example, the Y-axis direction.

In the embodiment, the reproducing section 70 can face two recording tracks included in the magnetic recording medium 80 at the same time. The electrical resistance of the first magnetic element 10A changes depending on the change in the recording state of the two recording tracks. Information recorded on the magnetic recording medium 80 can be reproduced by detecting the signal obtained from the first magnetic element 10A.

For example, the third magnetic layer 13 functions as a reference layer. The first magnetic layer 11 and the second magnetic layer 12 function as free layers. The magnetization of the free layer changes in response to changes in the recording states of the two recording tracks. A change in the free layer magnetization changes the angle between the reference layer magnetization and the free layer magnetization. The change in the first magnetic element 10A is based on the change in the angle of magnetization.

In the embodiment, the magnetization of the first magnetic layer 11 and the magnetization of the second magnetic layer 12 functioning as free layers are interlocked and stably For example, a magnetic field (for example, a 10 rotated. “horizontal magnetic field”) including a component in the third direction D3 is applied to these magnetic layers depending on the state of magnetization in the two recording tracks. The horizontal magnetic field causes the magnetization of these magnetic layers to rotate in a plane centered on the first direction D1. The magnetizations of these magnetic layers can be rotated in conjunction with each other in a stable manner with high precision. Thereby, a reproduced signal with less noise can be obtained.

According to the embodiment, a highly accurate signal with less noise can be obtained even when the pitch between multiple recording tracks is small. For example, high TPI (pitch per inch) can be obtained. According to the embodiment, for example, spatial resolution in the down-track direction can be improved. According to the embodiment, a magnetic head with improved characteristics can be provided.

The first magnetic element 10A may further include a first nonmagnetic layer 31. The first nonmagnetic layer 31 is provided between the first magnetic layer 11 and the second magnetic layer 12. The first nonmagnetic layer 31 includes, for example, at least one selected from the group consisting of Ru and Ir. A first nonmagnetic layer thickness t31 (see FIG. 1) of the first nonmagnetic layer 31 in the first direction D1 satisfies, for example, one of a first condition and a second condition. In the first condition, the first nonmagnetic layer 31 includes Ru, and the first nonmagnetic layer thickness t31 is not less than 0.1 nm and not more than 1 nm. In the second condition, the first nonmagnetic layer 31 includes Ir, and the first nonmagnetic layer thickness t31 is not less than 0.3 nm and not more than 0.8 nm. Such a first nonmagnetic layer 31 provides stable antiferromagnetic coupling in the first magnetic layer 11 and the second magnetic layer 12.

The first magnetic element 10A may further include a second nonmagnetic layer 32. The second nonmagnetic layer 32 is provided between the third magnetic layer 13 and the first magnetic layer 11. The second nonmagnetic layer 32 includes, for example, at least one selected from the group consisting of MgO, Al₂O₃, Cu, and Ag. For example, a high MR ratio can be obtained. A high-strength reproducing signal can be obtained. Noise can be suppressed.

A second nonmagnetic layer thickness t32 of the second nonmagnetic layer 32 along the first direction D1 is, for example, not less than 0.5 nm and not more than 2 nm. In one example, the first nonmagnetic layer thickness t31 may be thinner than the second nonmagnetic layer thickness t32 of the second nonmagnetic layer 32 in the first direction D1.

In the embodiment, the first magnetic layer magnetization 11M may be controlled by the shape anisotropy of the first magnetic layer 11 or the like. The second magnetic layer magnetization 12M may be controlled by the shape anisotropy of the second magnetic layer 12 or the like.

As in the example shown in FIGS. 1 and 2, the first magnetic element 10A may further include a first side magnetic layer 41 and a second side magnetic layer 42. At least a part of the first magnetic layer 11 is provided between the medium facing face 10F and the first side magnetic layer 41 in the second direction D2. At least a part of the second magnetic layer 12 is provided between the medium facing face 10F and the second side magnetic layer 42 in the second direction D2.

A first side magnetization 41M of the first side magnetic layer 41 includes a first side component along the second direction D2. A second side magnetization 42M of the second side magnetic layer 42 includes a second side component along the second direction D2. The direction of the second side component is opposite to the direction of the first side component. The second side magnetic layer 42 is antiferromagnetically coupled with the first side magnetic layer 41. The first side magnetic layer 41 and the second side magnetic layer 42 function as, for example, a bias applying section. The first side magnetic layer 41 and the second side magnetic layer 42 stably control the first magnetic layer magnetization 11M and the second magnetic layer magnetization 12M.

As shown in FIG. 1, the first magnetic element 10A may include a side nonmagnetic layer 49. The side nonmagnetic layer 49 is provided between the first side magnetic layer 41 and the second side magnetic layer 42. The material of the side nonmagnetic layer 49 may be the same as the material of the first nonmagnetic layer 31. The thickness of the side nonmagnetic layer 49 may be the same as the thickness of the first nonmagnetic layer 31.

As shown in FIGS. 1 and 2, the reproducing section 70 may further include a first shield 71 and a second shield 72. The first magnetic element 10A is provided between the first shield 71 and the second shield 72 in the first direction D1. A first shield magnetization 71M of the first shield 71 has the direction of the third component of the third magnetic layer magnetization 13M of the third magnetic layer 13. The second shield magnetization 72M of the second shield 72 has the direction of the third component.

The first magnetic element 10A may further include a third nonmagnetic layer 33 and a fourth nonmagnetic layer 34. The third nonmagnetic layer 33 is provided between the first shield 71 and the third magnetic layer 13 in the first direction D1. The fourth nonmagnetic layer 34 is provided between the second magnetic layer 12 and the second shield 72 in the first direction D1. The third nonmagnetic layer 33 includes, for example, Ta. The fourth nonmagnetic layer 34 includes, for example, Ta.

In one example, at least one of the first magnetic layer 11 or the second magnetic layer 12 includes at least one selected from the group consisting of Fe, Ni, and Co, for example. The first magnetic layer 11 and the second magnetic layer 12 are, for example, ferromagnetic layers. The third magnetic layer 13 includes, for example, at least one selected from the group consisting of Fe, Ni, and Co.

The first shield 71 and the second shield 72 include, for example, at least one selected from the group consisting of Fe, Ni, and Co.

At least one of the first side magnetic layer 41 or the second side magnetic layer 42 includes at least one selected from the group consisting of, for example, Fe, Ni, and Co.

The first magnetic layer thickness t11 of the first magnetic layer 11 in the first direction D1 may be, for example, not less than 2 nm and not more than 8 nm. The second magnetic layer thickness t12 of the second magnetic layer 12 in the first direction D1 may be, for example, not less than 2 nm and not more than 8 nm. The third magnetic layer thickness t13 of the third magnetic layer 13 in the first direction D1 may be, for example, not less than 2 nm and more than 8 nm.

For example, the first magnetic layer thickness t11 may be different from the second magnetic layer thickness t12. As a result, for example, the response of the magnetic recording medium 80 to the magnetic field becomes asymmetric. For example, the first magnetic layer thickness t11 may be different from the second magnetic layer thickness t12. For example, the output for the recording pattern of the magnetic recording medium 80 can be controlled to a desired state.

The third nonmagnetic layer thickness t33 of the third nonmagnetic layer 33 in the first direction D1 may be, for example, not less than 1 nm and not more than 3 nm. The fourth nonmagnetic layer thickness t34 of the fourth nonmagnetic layer 34 in the first direction D1 may be, for example, not less than 1 nm and not more than 3 nm.

As shown in FIG. 1, the reproducing section 70 may further include a first insulating member 10i. The first insulating member 10i may be provided around at least a part of the first magnetic element 10A between the first shield 71 and the second shield 72.

As shown in FIG. 3, a first side magnetic layer length w41 of the first side magnetic layer 41 along the third direction D3 may be longer than a first magnetic layer length w11 of the first magnetic layer 11 along the third direction D3. As shown in FIG. 4, a second side magnetic layer length w42 of the second side magnetic layer 42 along the third direction D3 may be longer than a second magnetic layer length w12 of the second magnetic layer 12 along the third direction D3.

FIG. 5 is a schematic diagram illustrating the magnetic head according to the first embodiment.

As shown in FIG. 5, the magnetic recording medium 80 includes a first track 87a and a second track 87b. The first track 87a includes a first region r1 and a second region r2. The second track 87b includes a third region r3 and a fourth region r4. A direction from the first region r1 to the second region r2 is along the first direction D1. A direction from the third region r3 to the fourth region r4 is along the first direction D1. A direction from the first region r1 to the third region r3 is along the third direction D3. A direction from the second region r2 to the fourth region r4 is along the third direction D3.

The reproducing section 70 is configured to output a signal according to the magnetization state of each of the first region r1, second region r2, third region r3, and fourth region r4. The state of magnetization corresponds to the recorded information. In one state, the reproducing section 70 faces the first region r1 and the third region r3. In one state, the reproducing section 70 faces the second region r2 and the fourth region r4.

Each of the first region r1, second region r2, third region r3, and fourth region r4 is configured to have one of a first recording state or a second recording state. The first recording state is one of a first magnetization state and a second magnetization state. The second recording state is the other of the first magnetization state and the second magnetization state. For example, the first magnetization state is one of upward magnetization and downward magnetization. The second magnetization state is the other of upward magnetization and downward magnetization. The magnetization of each of the first region r1, second region r2, third region r3, and fourth region r4 is set according to the intended recording information.

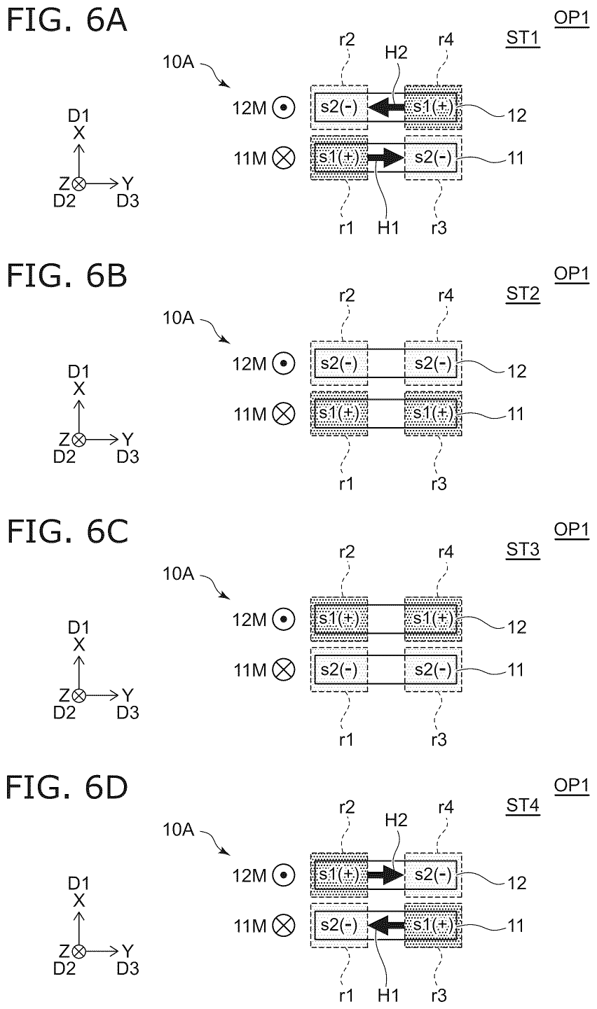

FIGS. 6A to 6D are schematic diagrams illustrating the magnetic head according to the first embodiment.

These figures illustrate some recorded information recorded on the magnetic recording medium 80. As shown in FIGS. 6A to 6D, in one operation state (first operation state OP1), at least a part of the first magnetic layer 11 faces to the first region r1 and the third region r3. In the first operation state OP1, at least a part of the second magnetic layer 12 faces the second region r2 and the fourth region r4.

FIG. 6A corresponds to the first state ST1 in the first operation state OP1. In the first state ST1, the first region r1 is in the first recording state s1, the second region r2 is in the second recording state s2, the third region r3 is in the second recording state s2, and the fourth region r4 is in the first recording state s1.

In one example, the first recording state s1 is upward magnetization, and the second recording state s2 is downward magnetization.

FIG. 6B corresponds to the second state ST2 in the first operation state OP1. In the second state ST2, the first region r1 is in the first recording state s1, the second region r2 is in the second recording state s2, the third region r3 is in the first recording state s1, and the fourth region r4 is in the second recording state s2.

FIG. 6C corresponds to the third state ST3 in the first operation state OP1. In the third state ST3, the first region r1 is in the second recording state s2, the second region r2 is in the first recording state s1, the third region r3 is in the second recording state s2, and the fourth region r4 is in the first recording state s1.

In the first state ST1, the magnetization state is different between the first region r1 and the third region r3, and the magnetization state is different between the second region r2 and the fourth region r4. Furthermore, the state of magnetization changes between the first region r1 and the second region r2. The state of magnetization changes between the third region r3 and the fourth region r4. In such a first state ST1, a first magnetic field H1 is applied to the first magnetic layer 11. The first magnetic field H1 includes a component along the third direction D3. A second magnetic field H2 is applied to the second magnetic layer 12. The second magnetic field H2 includes a component along the third direction D3. The direction of the second magnetic field H2 is opposite to the direction of the first magnetic field H1.

By such a first magnetic field H1 and a second magnetic field H2, the first magnetic layer magnetization 11M and the second magnetic layer magnetization 12M are rotated largely in conjunction with each other. As a result, the angle between the first magnetic layer magnetization 11M and the third magnetic layer magnetization 13M changes significantly.

On the other hand, in the second state ST2 and the third state ST3, the first magnetic layer magnetization 11M and the second magnetic layer magnetization 12M do not substantially change. Therefore, the electrical resistance does not substantially change between the second state ST2 and the third state ST3. On the other hand, the change in electrical resistance between the first state ST1 and the second state ST2 is large. The change in electrical resistance between the first state ST1 and the third state ST3 is large.

For example, an electrical resistance of the first magnetic element 10A in the first state ST1 is defined as a first state electrical resistance. An electrical resistance of the first magnetic element 10A in the second state ST2 is defined as a second state electrical resistance. An electrical resistance of the first magnetic element 10A in the third state ST3 is defined as a third state electrical resistance. A first absolute value of a first difference between the first state electrical resistance and the second state electrical resistance is greater than a second absolute value of a second difference between the second state electrical resistance and the third state electrical resistance. The second difference between the second state electrical resistance and the third state electrical resistance may be substantially zero.

By detecting such a difference (change) in electrical resistance, information recorded on the magnetic recording medium 80 can be reproduced.

FIG. 6D corresponds to a fourth state ST4 in the first operation state OP1. In the fourth state ST4, the first region r1 is in the second recording state s2, the second region r2 is in the first recording state s1, the third region r3 is in the first recording state s1, and the fourth region r4 is in the second recording state s2.

In the fourth state ST4, the first magnetic field H1 is applied to the first magnetic layer 11. The first magnetic field H1 includes a component along the third direction D3. The second magnetic field H2 is applied to the second magnetic layer 12. The second magnetic field H2 includes a component along the third direction D3. The direction of the second magnetic field H2 is opposite to the direction of the first magnetic field H1. The first magnetic layer magnetization 11M and the second magnetic layer magnetization 12M rotate largely in conjunction with each other.

As a result, the angle between the first magnetic layer magnetization 11M and the third magnetic layer magnetization 13M changes significantly.

For example, an electrical resistance of the first magnetic element 10A in the fourth state ST4 is defined as a fourth state electrical resistance. A third absolute value of a third difference between the fourth state electrical resistance and the second state electrical resistance is greater than the second absolute value.

In the example described above, the presence or absence of the difference in state between the first region r1 and the third region r3 and the presence or absence of the difference in state between the second region r2 and the fourth region r4 are used in the reproducing operation. For example, the output of the reproducing section 70 can differentially respond to a difference (change) in the state of a plurality of regions (bits) arranged in the track direction. Thereby, it becomes easy to obtain high resolution.

In the embodiment, recording and reproducing may be performed based on a combination of magnetization in the first track 87a and magnetization in the second track 87b. Furthermore, in the embodiment, recording and reproducing may be performed based on the state of one track. The magnetic head 110 may be applied to various recording/reproducing methods. For example, by using a recording/reproducing method based on a combination of magnetizations of a plurality of tracks, it is easy to obtain a high TPI even when the spatial resolution of the first magnetic element 10A is low. For example, high spatial resolution can be obtained in the down-track direction. A magnetic head with improved characteristics can be provided.

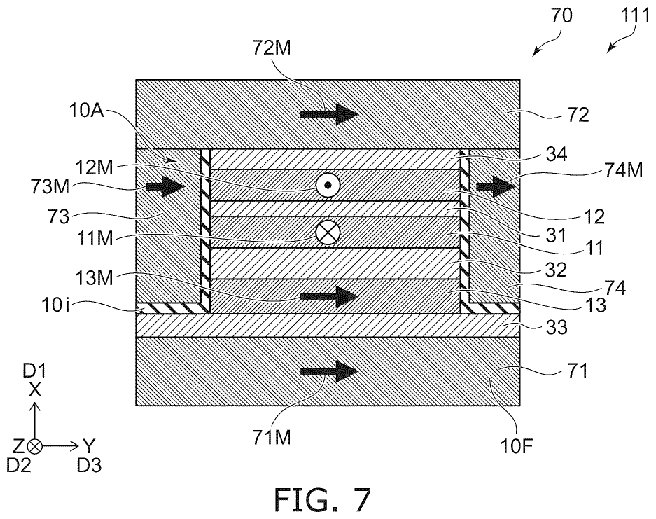

FIG. 7 is a schematic cross-sectional view illustrating a magnetic head according to the first embodiment.

As shown in FIG. 7, in a magnetic head 111 according to the embodiment, the reproducing section 70 further includes a third shield 73 and a fourth shield 74. The configuration of the magnetic head 111 other than this may be the same as the configuration of the magnetic head 110.

In the magnetic head 111, the first magnetic element 10A is provided between the third shield 73 and the fourth shield 74 in the third direction D3. A third shield magnetization 73M of the third shield 73 has a direction of the third component of the third magnetic layer magnetization 13M. A fourth shield magnetization 74M of the fourth shield 74 has a direction of the third component. Noise can be further reduced.

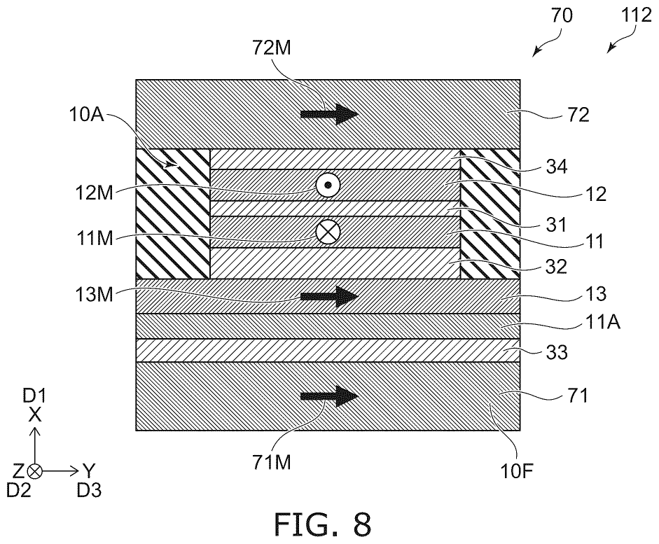

FIG. 8 is a schematic cross-sectional view illustrating a magnetic head according to the first embodiment.

As shown in FIG. 8, in s magnetic head 112 according to the embodiment, the first magnetic element 10A further includes a first additional magnetic layer 11A. The configuration of the magnetic head 112 other than this may be the same as the configuration of the magnetic head 110 or the magnetic head 111.

In the magnetic head 112, the third magnetic layer 13 is provided between the first additional magnetic layer 11A and the first magnetic layer 11 in the first direction D1. The first additional magnetic layer 11A includes IrMn. The first additional magnetic layer 11A is, for example, an antiferromagnetic layer. For example, the third magnetic layer magnetization 13M becomes more stable. A stable signal with suppressed noise can be obtained.

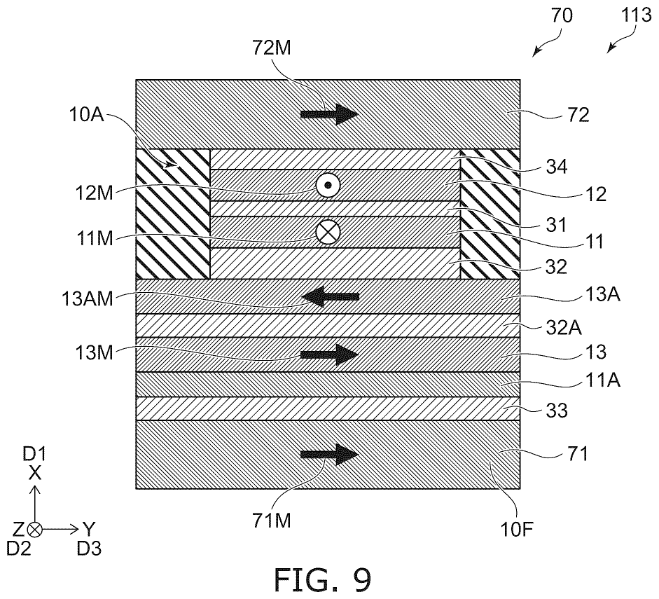

FIG. 9 is a schematic cross-sectional view illustrating a magnetic head according to the first embodiment.

As shown in FIG. 9, in a magnetic head 113 according to the embodiment, the first magnetic element 10A further includes a third opposing magnetic layer 13A and a second opposing nonmagnetic layer 32A. The configuration of the magnetic head 113 other than this may be the same as the configuration of the magnetic heads 110 to 112.

In the magnetic head 113, the third opposing magnetic layer 13A is provided between the third magnetic layer 13 and the second nonmagnetic layer 32 in the first direction D1. The second opposing nonmagnetic layer 32A is provided between the third magnetic layer 13 and the third opposing magnetic layer 13A in the first direction D1. For example, the second opposing nonmagnetic layer 32A includes Ru. A third opposing magnetic layer magnetization 13AM of the third opposing magnetic layer 13A is antiparallel to the third magnetic layer magnetization 13M of the third magnetic layer 13. For example, the third opposing magnetic layer 13A is antiferromagnetically coupled with the third magnetic layer 13. The magnetization of these magnetic layers becomes more stable. For example, noise is further suppressed. Higher characteristics can be obtained.

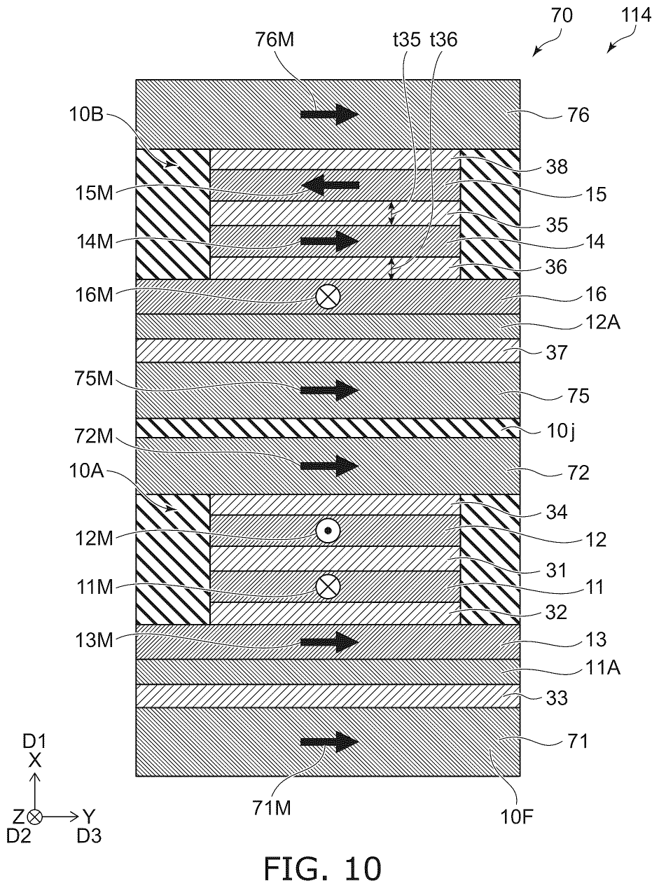

FIG. 10 is a schematic cross-sectional view illustrating a magnetic head according to the first embodiment.

As shown in FIG. 10, in a magnetic head 114 according to the embodiment, the reproducing section 70 further includes a second magnetic element 10B. The configuration of the magnetic head 114 other than this may be the same as the configuration of any of the magnetic heads 110 to 113.

In the magnetic head 114, the direction from the first magnetic element 10A to the second magnetic element 10B includes a component in the first direction D1. The second magnetic element 10B includes a fourth magnetic layer 14, a fifth magnetic layer 15, and a sixth magnetic layer 16. In the first direction D1, the fourth magnetic layer 14 is provided between the sixth magnetic layer 16 and the fifth magnetic layer 15.

A fourth magnetic layer magnetization 14M of the fourth magnetic layer 14 includes a fourth component along the third direction D3. A fifth magnetic layer magnetization 15M of the fifth magnetic layer 15 includes a fifth component along the third direction D3. The direction of the fifth component is opposite to the direction of the fourth component. A sixth magnetic layer magnetization 16M of the sixth magnetic layer 16 includes a sixth component along the second direction D2.

With such a second magnetic element 10B, for example, a magnetic field along the second direction D2 based on the magnetization of the magnetic recording medium 80 can be detected. Information recorded on the magnetic recording medium 80 can be detected with higher accuracy.

For example, multi-level data may be reproduced by processing a signal obtained from the first magnetic element 10A and a signal obtained from the second magnetic element 10B in combination.

For example, the second magnetic element 10B further includes a fifth nonmagnetic layer 35 provided between the fourth magnetic layer 14 and the fifth magnetic layer 15. The fifth nonmagnetic layer 35 satisfies one of a third condition and a fourth condition. In the third condition, the fifth nonmagnetic layer 35 includes Ru, and a fifth nonmagnetic layer thickness t35 in the first direction D1 is not less than 0.1 nm and not more than 1 nm. In the fourth condition, the fifth nonmagnetic layer includes Ir, and the fifth nonmagnetic layer thickness t35 is not less than 0.3 nm and not more than 0.8 nm.

The second magnetic element 10B may further include a sixth nonmagnetic layer 36 provided between the sixth magnetic layer 16 and the fourth magnetic layer 14. The sixth nonmagnetic layer 36 includes at least one selected from the group consisting of MgO, Al₂O₃, Cu, and Ag. it becomes easy to obtain large resistance changes.

A sixth nonmagnetic layer thickness t36 of the sixth nonmagnetic layer 36 along the first direction D1 is, for example, not less than 0.5 nm and not more than 2 nm. The fifth nonmagnetic layer thickness t35 may be thinner than the sixth nonmagnetic layer thickness t36 of the sixth nonmagnetic layer 36 in the first direction D1.

The reproducing section 70 may include a fifth shield 75 and a sixth shield 76. The second magnetic element 10B is provided between the fifth shield 75 and the sixth shield 76 in the first direction D1. A fifth shield magnetization 75M of the fifth shield 75 crosses the sixth magnetic layer magnetization 16M of the sixth magnetic layer 16. The fifth shield magnetization 75M includes, for example, a component in the third direction D3. The sixth shield magnetization 76M of the sixth shield 76 crosses the sixth magnetic layer magnetization 16M. For example, the sixth shield magnetization 76M is parallel to the fifth shield magnetization 75M. For example, the fifth shield magnetization 75M and the sixth shield magnetization 76M are along the third direction D3. For example, an insulating layer 10j may be provided between the second shield 72 and the fifth shield 75.

The second magnetic element 10B may include a seventh nonmagnetic layer 37 and an eighth nonmagnetic layer 38. The seventh nonmagnetic layer 37 is provided between the fifth shield 75 and the sixth magnetic layer 16 in the first direction. The eighth nonmagnetic layer 38 is provided between the fifth magnetic layer 15 and the sixth shield 76 in the first direction. The seventh nonmagnetic layer 37 includes, for example, Ta. The eighth nonmagnetic layer 38 includes, for example, Ta.

The second magnetic element 10B may further include a second additional magnetic layer 12A. The sixth magnetic layer 16 is provided between the second additional magnetic layer 12A and the fourth magnetic layer 14 in the first direction D1. The second additional magnetic layer 12A includes IrMn. The second additional magnetic is, layer 12A for example, an antiferromagnetic layer. For example, the sixth magnetic layer magnetization 16M becomes more stable. A stable signal with suppressed noise can be obtained.

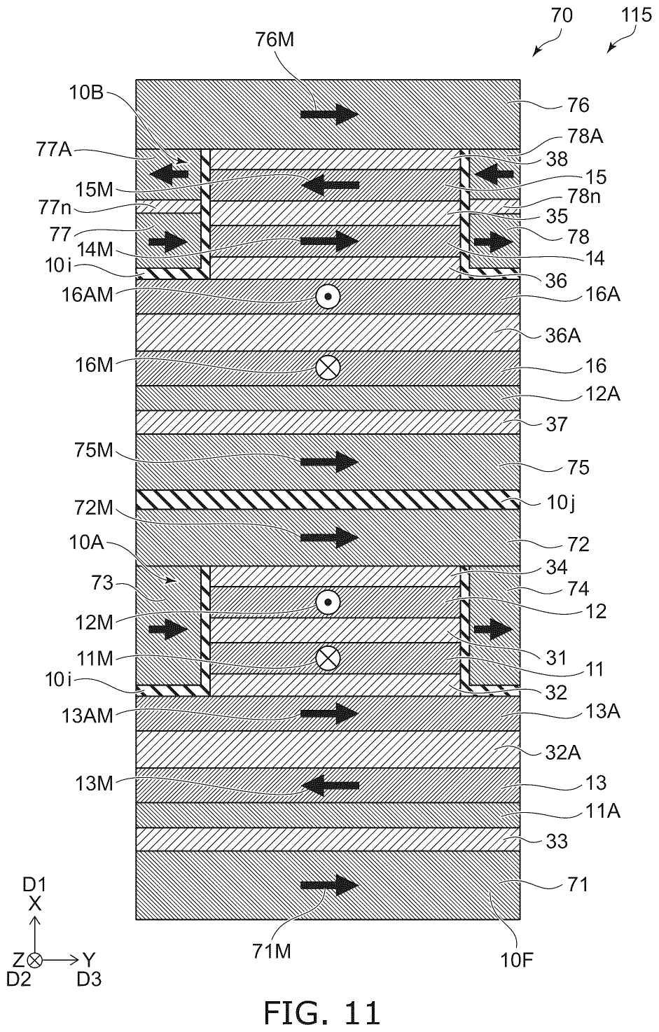

FIG. 11 is a schematic cross-sectional view illustrating a magnetic head according to the first embodiment.

As shown in FIG. 11, also in a magnetic head 115 according to the embodiment, the reproducing section 70 includes the first magnetic element 10A and the second magnetic element 10B. The first magnetic element 10A includes the third shield 73 and the fourth shield 74. The configuration of the magnetic head 115 other than this may be the same as the configuration of the magnetic head 114.

In the magnetic head 115, the first magnetic element 10A includes the third opposing magnetic layer 13A and the second opposing nonmagnetic layer 32A.

In the magnetic head 115, the second magnetic element 10B further includes a sixth opposing magnetic layer 16A and a sixth opposing nonmagnetic layer 36A. The sixth opposing magnetic layer 16A is provided between the sixth magnetic layer 16 and the sixth nonmagnetic layer 36 in the first direction D1. The sixth opposing nonmagnetic layer 36A is provided between the sixth magnetic layer 16 and the sixth opposing magnetic layer 16A in the first direction D1. For example, the sixth opposing nonmagnetic layer 36A includes Ru. A sixth opposing magnetic layer magnetization 16AM of the sixth opposing magnetic layer 16A is antiparallel to the sixth magnetic layer magnetization 16M of the sixth magnetic layer 16. For example, the sixth opposing magnetic layer 16A is antiferromagnetically coupled with the sixth magnetic layer 16. The magnetization of these magnetic layers becomes more stable. For example, noise is further suppressed. Higher characteristics can be obtained.

The second magnetic element 10B includes a seventh shield 77, a seventh opposing shield 77A, an eighth shield 78, and an eighth opposing shield 78A. The fourth magnetic layer 14 is provided between the seventh shield 77 and the eighth shield 78 in the third direction D3. The fifth magnetic layer 15 is provided between the seventh opposing shield 77A and the eighth opposing shield 78A in the third direction D3. The second magnetic element 10B may further include a seventh intermediate nonmagnetic layer 77n and an eighth intermediate nonmagnetic layer 78n. The seventh intermediate nonmagnetic layer 77n is provided between the seventh shield 77 and the seventh opposing shield 77A. The eighth intermediate nonmagnetic layer 78n is provided between the eighth shield 78 and the eighth opposing shield 78A. These intermediate nonmagnetic layers include, for example, Ru. For example, a magnetization of the seventh opposing shield 77A is antiparallel to a magnetization of the seventh shield 77. For example, a magnetization of the eighth opposing shield 78A is antiparallel to a magnetization of the eighth shield 78.

In the magnetic head 115 as well, multi-value data may be reproduced, for example, by processing a signal obtained from the first magnetic element 10A and a signal obtained from the second magnetic element 10B in combination.

In the embodiment, information regarding the direction of magnetization may be obtained by, for example, measuring the characteristics (electrical resistance) of the magnetic element while applying external magnetization to the reproducing section 70. Information regarding the direction of magnetization may be obtained using, for example, a magnetic force microscope. in a case where the element size and the recording area of the magnetic recording medium 80 are small, it may be difficult to obtain accurate information using the above method.

Hereinafter, several examples of reproducing methods applicable to the embodiment will be described. In the following description, the first region r1 is in the first recording state s1 or the second recording state s2. For simplicity, the first recording state s1 is written as “+” and the second recording state s2 is written as “−”. The combination of recording states of (first region r1, third region r3) is one of (−,−), (−,+), (+,−), and (+,+). The combination of recording states of (second region r2, fourth region 4) is one of (−,−), (−,+), (+,−), and (+,+).

In a first pattern, (first region r1, third region r3) is (−,−), and (second region r2, fourth region r4) is (−,−).

In a second pattern, (first region r1, third region r3) is (−, −), and (second region r2, fourth region r4) is (−, +).

In a third pattern, (first region r1, third region r3) is (−, −), and (second region r2, fourth region r4) is (+,−).

In a fourth pattern, (first region r1, third region r3) is (−, −), and (second region r2, fourth region r4) is (+, +).

In a fifth pattern, (first region r1, third region r3) is (−, +), and (second region r2, fourth region r4) is (−,−).

In a sixth pattern, (first region r1, third region r3) is (−, +), and (second region r2, fourth region r4) is (−, +).

In a seventh pattern, (first region r1, third region r3) is (−, +), and (second region r2, fourth region r4) is (+,−).

In an eighth pattern, (first region r1, third region r3) is (−, +), and (second region r2, fourth region r4) is (+, +).

In a ninth pattern, (first region r1, third region r3) is (+, −), and (second region r2, fourth region r4) is (−,−).

In a tenth pattern, (first region r1, third region r3) is (+, −), and (second region r2, fourth region r4) is (−, +).

In an eleventh pattern, (first region r1, third region r3) is (+,−), and (second region r2, fourth region r4) is (+,−).

In a twelfth pattern, (first region r1, third region r3) is (+, −), and (second region r2, fourth region r4) is (+, +).

In a thirteenth pattern, (first region r1, third region r3) is (+, +), and (second region r2, fourth region r4) is (−,−).

In a fourteenth pattern, (first region r1, third region r3) is (+, +), and (second region r2, fourth region r4) is (−, +).

In a fifteenth pattern, (first region r1, third region r3) is (+, +), and (second region r2, fourth region r4) is (+,−).

In a sixteenth pattern, (first region r1, third region r3) is (+, +), and (second region r2, fourth region r4) is (+, +).

In a first reproducing method regarding the second magnetic element 10B, five-value information is applied. In a third reproducing method, for example, the following configuration may be applied.

In the first pattern, the output is 0 and corresponds to the sign of “0”.

In the second pattern, the output is 0.5, corresponding to the sign of “0.5”.

In the third pattern, the output is 0.5, corresponding to the sign of “0.5”.

In the fourth pattern, the output is 1, which corresponds to the sign of “1”.

In the fifth pattern, the output is −0.5, which corresponds to the sign of “−0.5”.

In the sixth pattern, the output is 0 and corresponds to the sign of “0”.

In the seventh pattern, the output is 0 and corresponds to the sign of “0”.

In the eighth pattern, the output is 0.5, which corresponds to the sign of “0.5”.

In the ninth pattern, the output is −0.5, which corresponds to the sign of “−0.5”.

In the tenth pattern, the output is 0 and corresponds to the sign of “0”.

In the 11th pattern, the output is 0 and corresponds to the sign of “0”.

In the twelfth pattern, the output is 0.5, which corresponds to the sign of “0.5”.

In the thirteenth pattern, the output is −1, which corresponds to the sign of “−1”.

In the fourteenth pattern, the output is −0.5, which corresponds to the sign of “−0.5”.

In the fifteenth pattern, the output is −0.5, which corresponds to the sign of “−0.5”.

In the sixteenth pattern, the output is 0, which corresponds to the sign of “0”.

In a second reproducing method regarding the first magnetic element 10A, five-value information is applied. In a fourth reproducing method, for example, the following configuration may be applied.

In the first pattern, the output is 0 and corresponds to the sign of “0”.

In the second pattern, the output is 0.5, corresponding to the sign of “0.5”.

In the third pattern, the output is −0.5, corresponding to the sign of “−0.5”.

In the fourth pattern, the output is 0 and corresponds to the sign of “0”.

In the fifth pattern, the output is −0.5, which corresponds to the sign of “−0.5”.

In the sixth pattern, the output is 0 and corresponds to the sign of “0”.

In the seventh pattern, the output is −1, which corresponds to the sign of “−1”.

In the eighth pattern, the output is −0.5, which corresponds to the sign of “−0.5”.

In the ninth pattern, the output is 0.5, which corresponds to the sign of “0.5”.

In the tenth pattern, the output is 1, which corresponds to the code “1”.

In the eleventh pattern, the output is 0 and corresponds to the sign of “0”.

In the twelfth pattern, the output is 0.5, which corresponds to the sign of “0.5”.

In the thirteenth pattern, the output is 0 and corresponds to the sign of “0”.

In the fourteenth pattern, the output is 0.5, which corresponds to the sign of “0.5”.

In the fifteenth pattern, the output is −0.5, which corresponds to the sign of “−0.5”.

In the sixteenth pattern, the output is 0, which corresponds to the sign of “0”.

The signal (information) obtained by the above first reproducing method and the signal (information) obtained by the above second reproducing method may be combined. Reproducing may be performed depending on the result of the combination. In embodiments, a reproducing method of six or more values may be applied.

### Second Embodiment

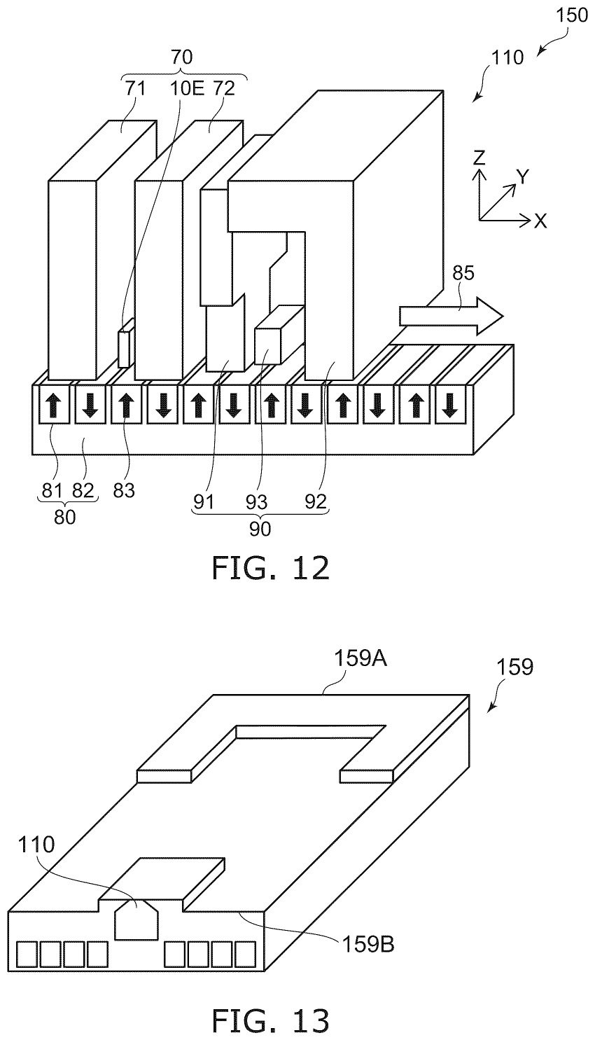

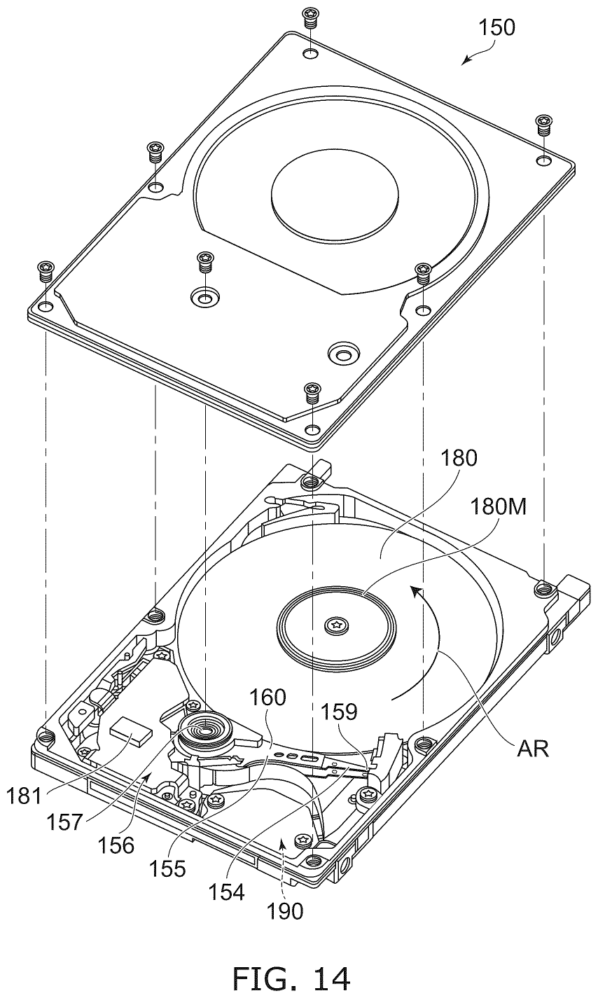

A magnetic recording device 150 (see FIGS. 12 and 14) according to the second embodiment includes the magnetic heads (magnetic heads 110 to 115 and modifications thereof) according to the first embodiment, and the magnetic recording medium 80. The magnetic recording medium 80 faces the medium facing face 10F. The reproducing section 70 is capable of reproducing information recorded on the magnetic recording medium 80.

The magnetic recording device 150 is configured to perform the operations described with respect to FIGS. 4A to 4D, for example. In the magnetic recording device 150, the first operation state OP1 is formed. In the magnetic recording device 150, at least one of the first state ST1, the second state ST2, the third state ST3, or a fourth state ST4 is formed. A magnetic recording device with improved characteristics can be provided.

FIG. 12 is a schematic perspective view illustrating the magnetic head and the magnetic recording device according to the second embodiment.

As shown in FIG. 12, the magnetic head 110 according to the embodiment includes a reproducing section 70. The magnetic head 110 is used together with the magnetic recording medium 80. In this example, the magnetic head 110 includes recording section 90. Information is recorded on the magnetic recording medium 80 by the recording section 90 of the magnetic head 110. The reproducing section 70 reproduces information recorded on the magnetic recording medium 80.

The magnetic recording medium 80 includes, for example, a medium substrate 82 and a magnetic recording layer 81 provided on the medium substrate 82. The magnetization 83 of the magnetic recording layer 81 is controlled by the recording section 90. The recording section 90 includes, for example, a first magnetic pole 91 and a second magnetic pole 92. The first magnetic pole 91 is, for example, a main magnetic pole. The second magnetic pole 92 is, for example, a trailing shield. The recording section 90 may include a recording section element 93. The recording section element 93 may include a magnetic field control element, a high frequency oscillation element, or the like. The recording section element 93 may be omitted.

As shown in FIG. 12, the magnetic recording medium 80 moves relative to the magnetic head 110 in a medium movement direction 85. The magnetic head 110 controls information corresponding to the magnetization 83 of the magnetic recording layer 81 at an arbitrary position. The magnetic head 110 reproduces information corresponding to the magnetization 83 of the magnetic recording layer 81 at an arbitrary position.

The X-axis direction corresponds to, for example, the down-track direction. The Y-axis direction corresponds to, for example, the cross-track direction. The Z-axis direction corresponds to, for example, the height direction.

FIG. 13 is a schematic perspective view illustrating a part of the magnetic recording device according to the embodiment.

FIG. 13 illustrates a head slider.

The magnetic head 110 is provided on the head slider 159. The head slider 159 includes, for example, Al₂O₃/TIC or the like. The head slider 159 moves relative to the magnetic recording medium while floating or in contact with the magnetic recording medium.

The head slider 159 includes, for example, an air inflow side 159A and an air outflow side 159B. The magnetic head 110 is arranged on the side surface of the air outflow side 159B of the head slider 159 or the like. As a result, the magnetic head 110 moves relative to the magnetic recording medium while flying above or in contact with the magnetic recording medium.

FIG. 14 is a schematic perspective view illustrating the magnetic recording device according to the embodiment.

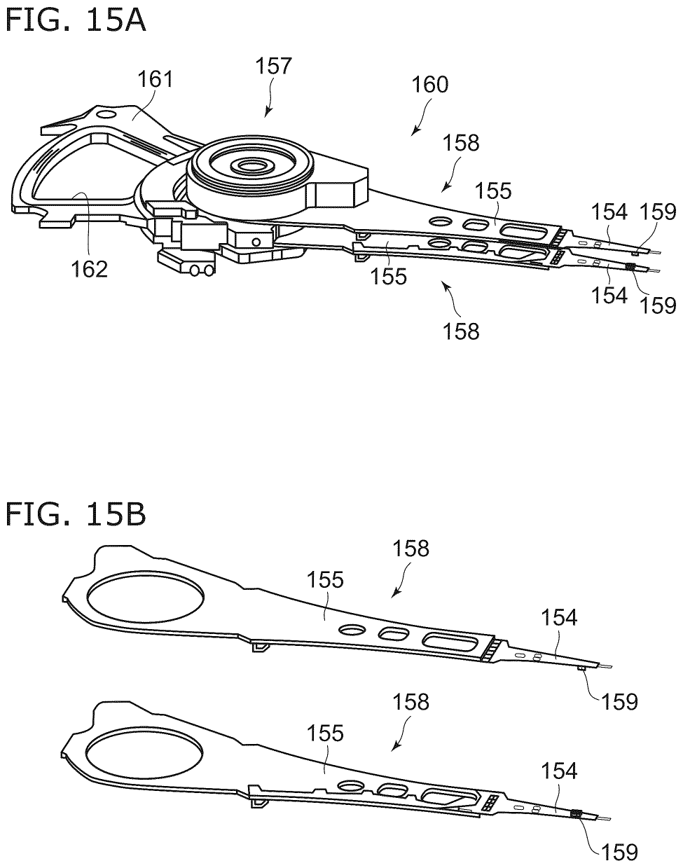

FIGS. 15A and 15B are schematic perspective views illustrating a part of the magnetic recording device according to the embodiment.

As shown in FIG. 14, in a magnetic recording device 150 according to the embodiment, a rotary actuator is used. The recording medium disk 180 is connected to a spindle motor 180M. The recording medium disk 180 is rotated in a direction of arrow AR by the spindle motor 180M. The spindle motor 180M is responsive to control signals from the drive device controller. The magnetic recording device 150 according to the embodiment may include the multiple recording medium disks 180. The magnetic recording device 150 may include a recording medium 181. The recording medium 181 is, for example, an SSD (Solid State Drive). A non-volatile memory such as a flash memory is used for the recording medium 181, for example. For example, the magnetic recording device 150 may be a hybrid HDD (Hard Disk Drive).

The head slider 159 records and reproduces information to be recorded on the recording medium disk 180. The head slider 159 is provided at an end of a thin-film suspension 154. A magnetic head according to the embodiment is provided near the end of the head slider 159.

While the recording medium disk 180 is rotating, the pressing pressure by the suspension 154 and the floating pressure generated at the medium facing face (ABS) of the head slider 159 are balanced. The distance between the medium facing face of the head slider 159 and the surface of the recording medium disk 180 is the predetermined fly height. In the embodiment, the head slider 159 may contact the recording medium disk 180. For example, a contact sliding type may be applied.

The suspension 154 is connected to one end of an arm 155 (e.g., an actuator arm). The arm 155 includes, for example, a bobbin part or the like. The bobbin part holds a drive coil. A voice coil motor 156 is provided at the other end of the arm 155. The voice coil motor 156 is a type of linear motor. The voice coil motor 156 includes, for example, a drive coil and a magnetic circuit. The drive coil is wound on the bobbin part of the arm 155. The magnetic circuit includes permanent magnets and opposing yokes. The drive coil is provided between the permanent magnet and the opposing yoke. The suspension 154 includes one end and the other end. The magnetic head is provided at one end of the suspension 154. The arm 155 is connected to the other end of the suspension 154.

The arm 155 is held by ball bearings. Ball bearings are provided at two locations above and below a bearing part 157. The arm 155 can be rotated and slid by the voice coil motor 156. The magnetic head can move to any position on the recording medium disk 180.

FIG. 15A is an enlarged perspective view of the head stack assembly 160, illustrating the configuration of a part of the magnetic recording device.

FIG. 15B is a perspective view illustrating the magnetic head assembly (head gimbal assembly: HGA) 158 that forms part of the head stack assembly 160.

As shown in FIG. 15A, the head stack assembly 160 includes the bearing part 157, the magnetic head assembly 158 and a support frame 161. The magnetic head assembly 158 extends from the bearing part 157. The support frame 161 extends from the bearing part 157. A direction in which the support frame 161 extends is opposite to a direction in which the magnetic head assembly 158 extends. The support frame 161 supports a coil 162 of the voice coil motor 156.

As shown in FIG. 15B, the magnetic head assembly 158 includes the arm 155 extending from the bearing part 157 and the suspension 154 extending from the arm 155.

The head slider 159 is provided at the end of the suspension 154. The head slider 159 is provided with the magnetic head according to the embodiment.

The magnetic head assembly 158 (head gimbal assembly) according to the embodiment includes the magnetic head according to the embodiment, the head slider 159 provided with the magnetic head, the suspension 154 and the arm 155. The head slider 159 is provided at one end of the suspension 154.

The arm 155 is connected to the other end of the suspension 154. The suspension 154 may include, for example, a wiring (not shown) for recording and reproducing signals. The suspension 154 may include, for example, a heater wiring (not shown) for adjusting the fly height. The suspension 154 may include a wiring (not shown) for, for example, an oscillator element or the like. These wires may be electrically connected to multiple electrodes provided on the magnetic head.

A signal processor 190 is provided in the magnetic recording device 150. The signal processor 190 uses a magnetic head to record and reproduce signals on a magnetic recording medium. Input/output lines of the signal processor 190 are connected to, for example, electrode pads of the magnetic head assembly 158 and electrically connected to the magnetic head.

The magnetic recording device 150 according to the embodiment includes the magnetic recording medium, the magnetic head according to the embodiment, a movable part, a position controller, and a signal processor. The movable part separates the magnetic recording medium from the magnetic head or makes them relatively movable while they are in contact with each other. The position controller aligns the magnetic head with a predetermined recording position on the magnetic recording medium. The signal processor records and reproduces signals on the magnetic recording medium using the magnetic head.

For example, the recording medium disk 180 is used as the above magnetic recording medium. The movable part includes, for example, the head slider 159. The position controller described above includes, for example, the magnetic head assembly 158.

The embodiments may include the following Technical proposals:

### (Technical Proposal 1)

A magnetic head, comprising:
a reproducing section including a medium facing face,
the reproducing section including a first magnetic element,
the first magnetic element including
a first magnetic layer;
a second magnetic layer; and
a third magnetic layer, the first magnetic layer being provided between the third magnetic layer and the second magnetic layer in a first direction along the medium facing face,
a first magnetic layer magnetization of the first magnetic layer including a first component along a second direction crossing the medium facing face,
a second magnetic layer magnetization of the second magnetic layer including a second component along the second direction,
a direction of the second component being opposite to a direction of the first component, and
a third magnetic layer magnetization of the third magnetic layer including a third component along a third direction crossing a plane including the first direction and the second direction.

### (Technical Proposal 2)

The magnetic head according to Technical proposal 1, wherein
the second magnetic layer is antiferromagnetically coupled with the first magnetic layer.

### (Technical Proposal 3)

The magnetic head according to Technical proposal 1 or 2, wherein
the first magnetic element further includes a first nonmagnetic layer provided between the first magnetic layer and the second magnetic layer,
the first nonmagnetic layer satisfies one of a first condition and a second condition,
in the first condition, the first nonmagnetic layer includes Ru, and a first nonmagnetic layer thickness of the first nonmagnetic layer in the first direction is not less than 0.1 nm and not more than 1 nm, and
in the second condition, the first nonmagnetic layer includes Ir, and the first nonmagnetic layer thickness is not less than 0.3 nm and not more than 0.8 nm.

### (Technical Proposal 4)

The magnetic head according to Technical proposal 3, wherein
the first magnetic element further includes a second nonmagnetic layer provided between the third magnetic layer and the first magnetic layer.

### (Technical Proposal 5)

The magnetic head according to Technical proposal 4, wherein
the second nonmagnetic layer includes at least one selected from the group consisting of MgO, Al₂O₃, Cu, and Ag.

### (Technical Proposal 6)

The magnetic head according to Technical proposal 4 or 5, wherein
the first nonmagnetic layer thickness is thinner than a second nonmagnetic layer thickness of the second nonmagnetic layer in the first direction.

### (Technical Proposal 7)

The magnetic head according to any one of Technical proposals 1-6, wherein
the first magnetic element further includes a first side magnetic layer and a second side magnetic layer,
at least a part of the first magnetic layer is provided between the medium facing face and the first side magnetic layer in the second direction,
at least a part of the second magnetic layer is provided between the medium facing face and the second side magnetic layer in the second direction,
a first side magnetization of the first side magnetic layer includes a first side component along the second direction,
a second side magnetization of the second side magnetic layer includes a second side component along the second direction,
a direction of the second side component is opposite to a direction of the first side component, and
the second side magnetic layer is antiferromagnetically coupled with the first side magnetic layer.

### (Technical Proposal 8)

The magnetic head according to any one of Technical proposals 1-7, wherein
the reproducing section further includes a first shield and a second shield,
the first magnetic element is provided between the first shield and the second shield in the first direction,
a first shield magnetization of the first shield has a direction of the third component, and
a second shield magnetization of the second shield has the direction of the third component.

### (Technical Proposal 9)

The magnetic head according to Technical proposal 8, wherein
the reproducing section further includes a third shield and a fourth shield,
the first magnetic element is provided between the third shield and the fourth shield in the third direction,
a third shield magnetization of the third shield has the orientation of the third component, and
a fourth shield magnetization of the fourth shield has the direction of the third component.

### (Technical Proposal 10)

The magnetic head according to any one of Technical proposals 1-9, wherein
at least one of the first magnetic layer or the second magnetic layer includes at least one selected from the group consisting of Fe, Ni, and Co, and
the third magnetic layer includes at least one selected from the group consisting of Fe, Ni, and Co.

### (Technical Proposal 11)

The magnetic head according to Technical proposal 7, wherein
at least one of the first magnetic layer or the second magnetic layer includes at least one selected from the group consisting of Fe, Ni, and Co,
the third magnetic layer includes at least one selected from the group consisting of Fe, Ni, and Co, and
at least one of the first side magnetic layer or the second side magnetic layer includes at least one selected from the group consisting of Fe, Ni, and Co.

### (Technical Proposal 12)

The magnetic head according to any one of Technical proposals 1-11, wherein
the first magnetic element further includes a first additional magnetic layer,
the third magnetic layer is provided between the first additional magnetic layer and the first magnetic layer in the first direction, and
the first additional magnetic layer includes IrMn.

### (Technical Proposal 13)

The magnetic head according to Technical proposal 8 or 9, wherein
the first magnetic element further includes a third nonmagnetic layer and a fourth nonmagnetic layer,
the third nonmagnetic layer is provided between the first shield and the third magnetic layer in the first direction, and
the fourth nonmagnetic layer is provided between the second magnetic layer and the second shield in the first direction.

### (Technical Proposal 14)

The magnetic head according to any one of Technical proposals 1-13, wherein
the reproducing section further includes a second magnetic element,
a direction from the first magnetic element to the second magnetic element includes a component of the first direction,
the second magnetic element includes:
a fourth magnetic layer;
a fifth magnetic layer; and
a sixth magnetic layer,
the fourth magnetic layer is provided between the sixth magnetic layer and the fifth magnetic layer in the first direction,
a fourth magnetic layer magnetization of the fourth magnetic layer includes a fourth component along the third direction,
a fifth magnetic layer magnetization of the fifth magnetic layer includes a fifth component along the third direction,
a direction of the fifth component is opposite to a direction of the fourth component, and
a sixth magnetic layer magnetization of the sixth magnetic layer includes a sixth component along the second direction.

### (Technical Proposal 15)

The magnetic head according to Technical proposal 14, wherein
the second magnetic element further includes a fifth nonmagnetic layer provided between the fourth magnetic layer and the fifth magnetic layer,
the fifth nonmagnetic layer satisfies one of a third condition and a fourth condition,
in the third condition, the fifth nonmagnetic layer includes Ru, and a fifth nonmagnetic layer thickness of the fifth nonmagnetic layer in the first direction is not less than 0.1 nm and not more than 1 nm, and
in the fourth condition, the fifth nonmagnetic layer includes Ir, and the fifth nonmagnetic layer thickness is not less than 0.3 nm and not more than 0.8 nm.

### (Technical Proposal 16)

The magnetic head according to Technical proposal 15, wherein
the second magnetic element further includes a sixth nonmagnetic layer provided between the sixth magnetic layer and the fourth magnetic layer, and
the sixth nonmagnetic layer includes at least one selected from the group consisting of MgO, Al₂O₃, Cu, and Ag.

### (Technical Proposal 17)

The magnetic head according to Technical proposal 16, wherein
the fifth nonmagnetic layer thickness is thinner than a sixth nonmagnetic layer thickness in the first direction of the sixth nonmagnetic layer.

### (Technical Proposal 18)

A magnetic recording device, comprising:
the magnetic head according to any one of Technical proposals 1-17; and
a magnetic recording medium facing the medium facing face,
the reproducing section being configured to reproduce information recorded on the magnetic recording medium.

### (Technical Proposal 19)

The magnetic recording device according to Technical proposal 18, wherein
the magnetic recording medium includes a first track and a second track,
the first track includes a first region and a second region,
the second track includes a third region and a fourth region,
a direction from the first region to the second region is along the first direction,
a direction from the third region to the fourth region is along the first direction,
a direction from the first region to the third region is along the third direction,
a direction from the second region to the fourth region is along the third direction, and
the reproducing section is configured to output a signal according to a state of magnetization of each of the first region, the second region, the third region, and the fourth region.

### (Technical Proposal 20)

The magnetic recording device according to Technical proposal 19, wherein
in one operating state, at least a part of the first magnetic layer faces the first region and the third region, and at least a part of the second magnetic layer faces the second region and the fourth region.

According to the embodiments, it is possible to provide a magnetic head and a magnetic recording device whose characteristics can be improved.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in magnetic heads and magnetic recording devices such as shields, magnetic layers, intermediate layers, terminals, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all magnetic heads and all magnetic recording devices practicable by an appropriate design modification by one skilled in the art based on the magnetic heads and the magnetic recording devices described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A magnetic head, comprising:
a reproducing section including a medium facing face,
the reproducing section including a first magnetic element,
the first magnetic element including
a first magnetic layer;
a second magnetic layer; and
a third magnetic layer, the first magnetic layer being provided between the third magnetic layer and the second magnetic layer in a first direction along the medium facing face,
a first magnetic layer magnetization of the first magnetic layer including a first component along a second direction crossing the medium facing face,
a second magnetic layer magnetization of the second magnetic layer including a second component along the second direction,
a direction of the second component being opposite to a direction of the first component, and
a third magnetic layer magnetization of the third magnetic layer including a third component along a third direction crossing a plane including the first direction and the second direction.

2. The magnetic head according to claim 1, wherein
the second magnetic layer is antiferromagnetically coupled with the first magnetic layer.

3. The magnetic head according to claim 1, wherein
the first magnetic element further includes a first nonmagnetic layer provided between the first magnetic layer and the second magnetic layer,
the first nonmagnetic layer satisfies one of a first condition and a second condition,
in the first condition, the first nonmagnetic layer includes Ru, and a first nonmagnetic layer thickness of the first nonmagnetic layer in the first direction is not less than 0.1 nm and not more than 1 nm, and
in the second condition, the first nonmagnetic layer includes Ir, and the first nonmagnetic layer thickness is not less than 0.3 nm and not more than 0.8 nm.

4. The magnetic head according to claim 3, wherein
the first magnetic element further includes a second nonmagnetic layer provided between the third magnetic layer and the first magnetic layer.

5. The magnetic head according to claim 4, wherein
the second nonmagnetic layer includes at least one selected from the group consisting of MgO, Al₂O₃, Cu, and Ag.

6. The magnetic head according to claim 4, wherein
the first nonmagnetic layer thickness is thinner than a second nonmagnetic layer thickness of the second nonmagnetic layer in the first direction.

7. The magnetic head according to claim 1, wherein
the first magnetic element further includes a first side magnetic layer and a second side magnetic layer,
at least a part of the first magnetic layer is provided between the medium facing face and the first side magnetic layer in the second direction,
at least a part of the second magnetic layer is provided between the medium facing face and the second side magnetic layer in the second direction,
a first side magnetization of the first side magnetic layer includes a first side component along the second direction,
a second side magnetization of the second side magnetic layer includes a second side component along the second direction,
a direction of the second side component is opposite to a direction of the first side component, and
the second side magnetic layer is antiferromagnetically coupled with the first side magnetic layer.

8. The magnetic head according to claim 1, wherein
the reproducing section further includes a first shield and a second shield,
the first magnetic element is provided between the first shield and the second shield in the first direction,
a first shield magnetization of the first shield has a direction of the third component, and
a second shield magnetization of the second shield has the direction of the third component.

9. The magnetic head according to claim 8, wherein
the reproducing section further includes a third shield and a fourth shield,
the first magnetic element is provided between the third shield and the fourth shield in the third direction,
a third shield magnetization of the third shield has the orientation of the third component, and
a fourth shield magnetization of the fourth shield has the direction of the third component.

10. The magnetic head according to claim 1, wherein
at least one of the first magnetic layer or the second magnetic layer includes at least one selected from the group consisting of Fe, Ni, and Co, and
the third magnetic layer includes at least one selected from the group consisting of Fe, Ni, and Co.

11. The magnetic head according to claim 7, wherein
at least one of the first magnetic layer or the second magnetic layer includes at least one selected from the group consisting of Fe, Ni, and Co,
the third magnetic layer includes at least one selected from the group consisting of Fe, Ni, and Co, and
at least one of the first side magnetic layer or the second side magnetic layer includes at least one selected from the group consisting of Fe, Ni, and Co.

12. The magnetic head according to claim 1, wherein
the first magnetic element further includes a first additional magnetic layer,
the third magnetic layer is provided between the first additional magnetic layer and the first magnetic layer in the first direction, and
the first additional magnetic layer includes IrMn.

13. The magnetic head according to claim 8, wherein
the first magnetic element further includes a third nonmagnetic layer and a fourth nonmagnetic layer,
the third nonmagnetic layer is provided between the first shield and the third magnetic layer in the first direction, and
the fourth nonmagnetic layer is provided between the second magnetic layer and the second shield in the first direction.

14. The magnetic head according to claim 1, wherein
the reproducing section further includes a second magnetic element,
a direction from the first magnetic element to the second magnetic element includes a component of the first direction,
the second magnetic element includes:
a fourth magnetic layer;
a fifth magnetic layer; and
a sixth magnetic layer,
the fourth magnetic layer is provided between the sixth magnetic layer and the fifth magnetic layer in the first direction,
a fourth magnetic layer magnetization of the fourth magnetic layer includes a fourth component along the third direction,
a fifth magnetic layer magnetization of the fifth magnetic layer includes a fifth component along the third direction,
a direction of the fifth component is opposite to a direction of the fourth component, and
a sixth magnetic layer magnetization of the sixth magnetic layer includes a sixth component along the second direction.

15. The magnetic head according to claim 14, wherein
the second magnetic element further includes a fifth nonmagnetic layer provided between the fourth magnetic layer and the fifth magnetic layer,
the fifth nonmagnetic layer satisfies one of a third condition and a fourth condition,
in the third condition, the fifth nonmagnetic layer includes Ru, and a fifth nonmagnetic layer thickness of the fifth nonmagnetic layer in the first direction is not less than 0.1 nm and not more than 1 nm, and
in the fourth condition, the fifth nonmagnetic layer includes Ir, and the fifth nonmagnetic layer thickness is not less than 0.3 nm and not more than 0.8 nm.

16. The magnetic head according to claim 15, wherein
the second magnetic element further includes a sixth nonmagnetic layer provided between the sixth magnetic layer and the fourth magnetic layer, and
the sixth nonmagnetic layer includes at least one selected from the group consisting of MgO, Al₂O₃, Cu, and Ag.

17. The magnetic head according to claim 16, wherein
the fifth nonmagnetic layer thickness is thinner than a sixth nonmagnetic layer thickness in the first direction of the sixth nonmagnetic layer.

18. A magnetic recording device, comprising:
the magnetic head according to claim 1; and
a magnetic recording medium facing the medium facing face,
the reproducing section being configured to reproduce information recorded on the magnetic recording medium.

19. The magnetic recording device according to claim 18, wherein
the magnetic recording medium includes a first track and a second track,
the first track includes a first region and a second region,
the second track includes a third region and a fourth region,
a direction from the first region to the second region is along the first direction,
a direction from the third region to the fourth region is along the first direction,
a direction from the first region to the third region is along the third direction,
a direction from the second region to the fourth region is along the third direction, and
the reproducing section is configured to output a signal according to a state of magnetization of each of the first region, the second region, the third region, and the fourth region.

20. The magnetic recording device according to claim 19, wherein
in one operating state, at least a part of the first magnetic layer faces the first region and the third region, and at least a part of the second magnetic layer faces the second region and the fourth region.
